(19) United States
(12) Patent Application Publication
(10) Pub. No.: US 2007/0242852 A1
(43) Pub. Date: Oct. 18, 2007

(54) Method and apparatus for watermarking sensed data

(75) Inventor: Akinlolu Oloruntosi Kumoluyi, Marietta, GA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/289,794

(22) Filed: Nov. 30, 2005

Related U.S. Application Data
(60) Provisional application No. 60/633,222, filed on Dec. 3, 2004.

(51) Int. Cl. G06K 9/00

(52) U.S. Cl. 382/100

(57) ABSTRACT

A method and apparatus for watermarking sensed data in a sensing device which senses a subject to obtain sensed data includes the sensing device temporarily storing the sensed data. The sensing device collects metadata associated with a user of the sensing device and temporarily stores the metadata. The sensing device generates watermarked data by watermarking the sensed data with the metadata.

### CROSS REFERENCED TO RELATED APPLICATIONS

This application claims priority to U.S. Provisional Application No. 60/633,222, filed on Dec. 3, 2004, which is incorporated by reference herein as if fully set forth.

### FIELD OF INVENTION

The present invention relates to sensed data. More particularly, the present invention relates to a method and apparatus for embedding watermarks on sensed data in order to foster tracking of data and to determine an origination source of the sensed data.

### BACKGROUND

With ever increasing sophistication in available technology, piracy of intellectual property has become widespread. Pirated movies on DVD or VHS often appear concurrently with the first run of the movies in theaters. Making anti-piracy efforts even more difficult, electronic sensing devices, such as cameras, microphones, and/or speakerphones, or the like, which used to be somewhat bulky have become miniaturized. Accordingly, the physical presence of them often escapes detection. Electronic sensing devices performing optical, audible or any other type of electronic data collection can now be embedded in phones, personal digital assistants (PDAs), watches, or any other device that a manufacturer desires.

It has therefore become easier than ever to secrete a sensing device into an event such as a play, movie, business establishment or the like to perform unauthorized recording of data.

These electronic sensing devices (hereafter “sensing devices”) can record and/or transmit images and sounds that are not authorized to be recorded or transmitted by the individual recording them. Once a scene or a sound has been captured, the sensed data may be distributed fairly easily through a variety of channels, including the Internet. In many cases it is difficult to determine the source of the pirated data, and therefore intellectual property owners are forced to endure a financial loss.

Attempts have been made to regulate miniaturized sensing devices by either posting restrictions in restricted areas or by searching for their existence. These methods are often difficult to enforce, ineffective and inefficient.

Unauthorized sensing can also be controlled with systems which broadcast radio frequency (RF) beacons that signal sensing devices to disable their sensing functionality. The problem with regulating sensing devices by this method is that a sensing device must be equipped in order to receive such RF signals, and a large number of sensing devices do not include such functionality. Further, in those devices that are so equipped, the RF receiving functionality can easily be disabled. Importantly however, this does not solve the problem for the large number of devices which are not so equipped.

Since these modern sensing devices often come integrated with functionality such as increased storage capacity and the ability to transmit data wirelessly, larger quantities of data can be stored and transferred in a timely manner. However, one feature that these sensing devices currently do not have is a provision for attaching metadata to their primary sensed data. Metadata, in general, is data about the data. For example, metadata about a data file could be data about the individual who created the data (such as a fingerprint, an iris or retina scan or the like), when the data was created, and the program with which the data was created. Just about any type of information about the data can form the basis of metadata. For a document such as a word processing document, metadata could describe the attributes such as the author, date of creation, size of file, date last modified and number of revisions, or the like. This metadata could then provide the ability to trace, track, and authenticate the data.

Biometrics can be employed in many cases to collect the metadata, and in particular, the unique identification of the photographer or audio recorder. Biometrics generally collect unique data to identify a person, such as his or her physiological or behavioral characteristics. For example, a physiological biometric could be recognition of characteristics associated with a person's face, iris, retina, hand and fingerprints. Behavioral characteristics could include recognition of a person's voice or written signature. The fingerprint biometric is often used because it is relatively easy to collect, difficult to replicate, and uniquely identifies the photographer or audio recorder at any point in time during operation of a sensing device. Personal Identification Numbers (PINs), passwords, or the like can be stolen and used by any individual, and are thereby less secure than using fingerprint data or other biometric metadata.

Other types of metadata include the environmental conditions surrounding a subject captured by the sensing device, such as the temperature, the pressure, the humidity, or the like.

Current sensing devices, though, simply focus on their primary task of capturing images and sounds, and do not utilize attaching metadata to the sensed data in order to watermark the data. Thus, any sensed data without a watermark cannot be traced, tracked, or authenticated. Accordingly, it is desirable to have a method and apparatus for watermarking data by attaching metadata to sensed data for the purposes of tracing, tracking and authenticating the sensed data.

### SUMMARY

A method and apparatus for watermarking sensed data in a sensing device which senses a subject to obtain sensed data includes the sensing device temporarily storing the sensed data. The sensing device collects metadata associated with a user of the sensing device and temporarily stores the metadata. The sensing device generates watermarked data by watermarking the sensed data with the metadata.

### BRIEF DESCRIPTION OF THE DRAWINGS

The foregoing summary, as well as the following detailed description of the preferred embodiments of the present invention will be better understood when read with reference to the appended drawings, wherein:

FIG. 1 shows a sensing device capturing data in accordance with the present invention;

FIG. 2 is a detailed block diagram of the sensing device of FIG. 1;

FIG. 3 is a functional block diagram of a processor in the sensing device of FIG. 2; and

FIG. 4 is a flow diagram of a process of watermarking sensed data in accordance with the present invention.

### DETAILED DESCRIPTION OF THE PREFERRED EMBODIMENTS

Hereafter, the terminology “sensing device” includes, but is not limited to, a wireless transmit/receive unit (WTRU), a user equipment (UE), a computer, a mobile station, a fixed or mobile subscriber unit, a pager, a camera, a sound recorder, or any other type of device capable of sensing and recording data such as an image, video, sound, temperature, humidity, pressure, or any other type of data that can be sensed. When referred to hereafter, an access point (AP) includes a base station or a radio network controller (RNC), including but not limited to a Node-B, site controller, or any other type of interfacing device in a wireless environment.

The features of the present invention may be incorporated into an integrated circuit (IC) or be configured in a circuit comprising a multitude of interconnecting components.

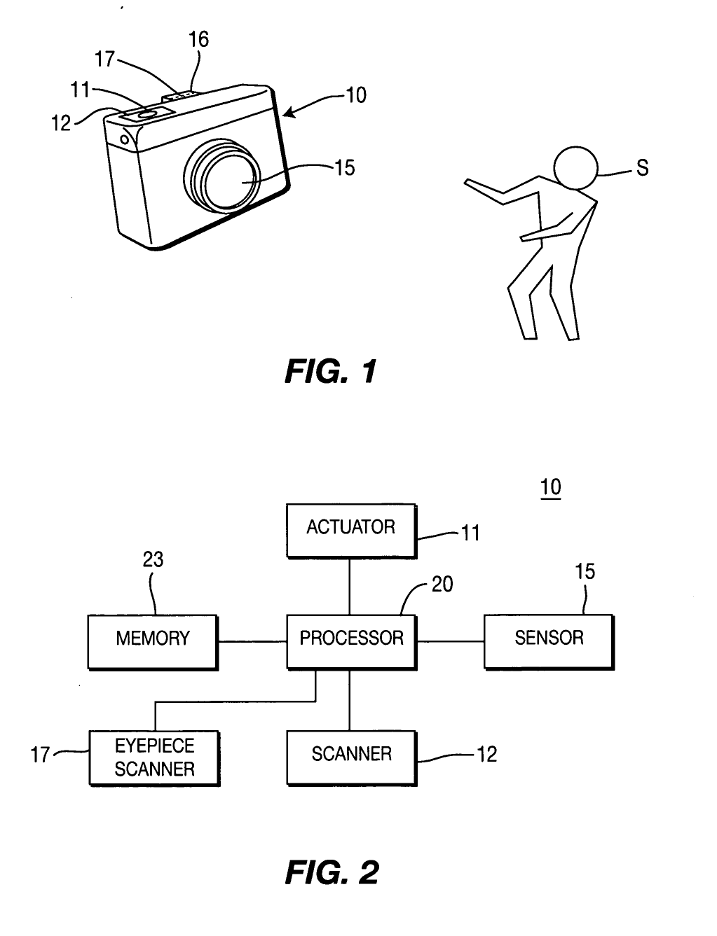

FIG. 1 shows a sensing device 10 in the process of sensing a subject S as data. For purposes of example, the sensing device 10 in a preferred embodiment of the present invention is a camera. However the sensing device 10 may be any sensing device known to one of ordinary skill in the art. The sensing device 10 includes a scanner 12 disposed upon the sensing device 10, an actuator 11 disposed upon the scanner 12, an eyepiece 16 disposed upon the sensing device 10, an eyepiece scanner 17 disposed within the eyepiece, and a sensor 15. In a preferred embodiment of the present invention, the sensor 15 may be a lens for sensing visual data, and/or a microphone for sensing audio data. As previously stated, the sensor 15 may also include any other type of sensor known to one of ordinary skill in the art, such as a sensor for sensing temperature, pressure, humidity, or any other type of data that can be sensed. Moreover, in a preferred embodiment of the present invention, the actuator 11 is operatively connected to the scanner 12, eyepiece scanner 17, and sensor 15 components, such that when a user actuates the actuator 11, one or more of the operatively connected components are activated. Furthermore, the actuator 11 in a preferred embodiment is a button disposed upon the sensing device 10.

Although the generation of a watermark and its imparting upon a subject is not within the scope of the present invention, a watermark may be imparted upon the subject S in a variety of ways. For example, the watermark may be generated by a watermark generator (not shown) in the environment where the subject S resides. That is, the watermark generator may project the watermark onto the subject S from a location proximate to the subject S. Where an external watermark is imparted into an environment (e.g. on the subject S by an external watermark generator), the present invention assumes that the sensing device 10 will sense the externally generated watermark.

The scanner 12, in a preferred embodiment of the present invention, is an optical scanner capable of detecting biometric metadata such as a fingerprint. However, the scanner 12 may be capable of detecting environmental conditions, such as a sensor for sensing temperature, pressure, humidity, or the like. Similarly, the eyepiece scanner 17, in a preferred embodiment of the present invention is a scanner capable of detecting biometric metadata such as that obtained through performing an iris or retina scan. The eyepiece scanner 17 may also include a scanner capable of detecting environmental conditions, such as a sensor for sensing temperature, pressure, humidity, or the like.

FIG. 2 is a block diagram of the sensing device 10 configured to perform a method of watermarking sensed data, in accordance with the present invention. In addition to the nominal components of a typical sensing device (e.g., a camera or recorder) which are not specifically shown, the sensing device 10 includes a processor 20 configured to process sensed data and a memory 23 in communication with the processor 20. The sensor 15, the actuator 11, the scanner 12, and the eyepiece scanner 17 are all also in communication with the processor 20. In a preferred embodiment of the present invention, the memory 23 is a memory circuit. However, the memory 23 may be a removable media within the sensing device 10, such as a memory card, tape or other similar media.

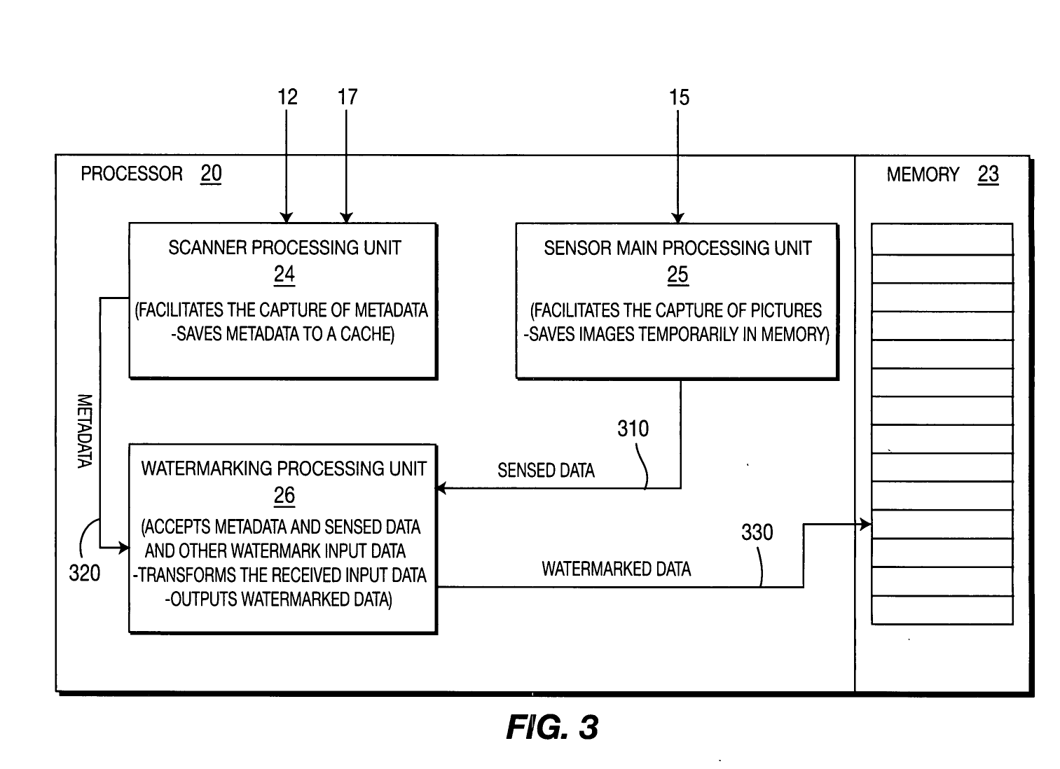

FIG. 3 is a functional block diagram of the processor 20 and the memory 23 in the sensing device 10, in accordance with the present invention. The sensor 15 senses the subject S as sensed data and transfers it to a sensor main processing unit 25 within the processor 20. If an external identifying watermark is imparted upon the subject S, then the sensor 15 also captures and transfers the external identifying watermark to the sensor main processing unit 25. The scanner 12 captures metadata, such as fingerprint data of the user operating the actuator 11, and transfers the fingerprint data to a scanner processing unit 24 within the processor 20. Additionally, or optionally, the eyepiece scanner 17 captures metadata associated with, for example, an iris scan, or a retina scan of a person operating the sensing device 10, and transfers it to the scanner processing unit 24. In a preferred embodiment of the present invention, the sensing device 10 includes both the scanner 12 and the eyepiece scanner 17. However, one of ordinary skill in the art can readily appreciate that the sensing device 10 may include only one of the scanner 12 and the eyepiece scanner 17.

The scanner processing unit 24 transfers the metadata 320 received from either the scanner 12, the eyepiece scanner 17, or both to a watermarking processing unit 26. The sensor processing unit 25 also transfers the sensed data 310 to the watermarking processing unit 26 for further processing. The watermarking processing unit 26 watermarks the sensed data by encoding the metadata to the sensed data and transfers the resulting watermarked data 330 to the memory 23, where the watermarked data can be retrieved and processed at a later time.

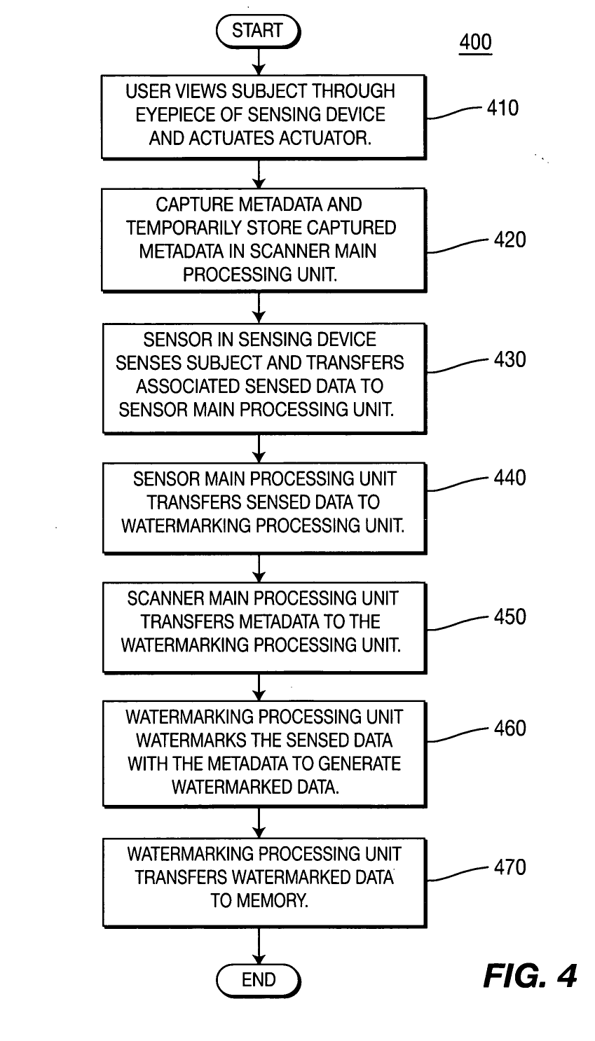

FIG. 4 is a flow diagram of a preferred process 400 of watermarking sensed data with metadata, in accordance with the present invention. In step 410, the user of the sensing device 10 looks through the eyepiece 16 and actuates the actuator 11.

In step 420, the actuation of the actuator 11 activates the scanner 12 and/or the eyepiece scanner 17. The scanner 12 captures the fingerprint metadata of the user actuating the actuator 11 of the sensing device 10. Likewise, the eyepiece scanner 17 captures an iris scan, a retina scan, or both, as metadata during the actuation of the actuator 11. The scanner 12 and the eyepiece scanner 17 transfer the metadata to the scanner processing unit 24. The captured metadata is stored temporarily in a cache within the scanner processing unit 24.

In step 430, the actuator 11 activates the sensor 15, which senses the subject S as sensed data and transfers the data to the sensor main processing unit 25, where it is temporarily stored in a memory within the sensor main processing unit 25.

The sensor main processing unit 25 transfers the sensed data to the watermarking main processing unit 26 for further processing (step 440). Additionally, the sensor main processing unit 25 transfers any external metadata, such as any external watermarking which is imparted upon the subject S.

In step 450, the scanner processing unit 24 transfers the metadata captured by the scanner 12 and/or the eyepiece scanner 17 to the watermarking processing unit 26. As previously described, in a preferred embodiment of the present invention, the scanner 12 and the eyepiece scanner 17 are biometric scanners that capture biometric metadata such as fingerprints, face, iris, retina and hand characteristics. However, any known type of metadata can be captured, such as the conditions in which the sensed data was sensed by the sensor 15, including, but not limited to, the temperature, the pressure, the location, the date, or the time that the subject S was sensed.

The watermarking processing unit 26 accepts the sensed data from the sensor main processing unit 25 and the metadata from the scanner processing unit 24. The watermarking processing unit 26 then generates watermarked data by watermarking the sensed data with the metadata (step 460). Preferably, the watermarking processing unit 26 encodes the metadata into the sensed data in an inconspicuous manner. In a preferred embodiment of the present invention, the metadata must be undetectable and secured such that it is resilient to all forms of mutilations including alterations, digital and analog copying, or the like. The watermark must inextricably bind the metadata to the sensed data without interfering with the appearance, readability or audibility of the sensed data. That is, there must be no loss of audio, image, or video quality of the sensed data from the addition of the metadata.

Additionally, the sensing device 10 may be assigned specific identifying watermarks based on the sensing functions of the device, such as video recording or audio recording. In a preferred embodiment of the present invention, these specific identifying watermarks may be stored in the memory 23 of the sensing device 10 for encoding into the watermarked data. Since each sensing function and each sensing device 10 can have distinctive characteristics, such as the type of sensor, strength of sensor, location of sensor, sensing directional pattern, serial number of the sensing device, name, identity, and contact information of the primary user of the device, or the like, metadata containing this information may be encoded into any sensed data captured by the sensing device 10. These attributes can then be combined with metadata such as the fingerprint data obtained from the scanner 12, or an iris scan obtained from the eyepiece scanner 17 to form the watermark. The watermark is then dispersed appropriately within an image or sound, which all together form the watermarked data, which preferably appears to be identical to (or an unaltered version of) the original sensed data to a casual observer.

In step 470, the watermarking processing unit 26 of the processor 20 transfers the watermarked data to the memory 23 of the sensing device 10. The watermarked data can be extracted at a later time from the memory 23.

As shown in FIG. 1, the actuator 11 is disposed upon the scanner 12. Although it may be a nuisance if the actuator 11 is rendered inoperable when a finger is not on the scanner 12, this arrangement ensures that data is not sensed without having the fingerprints of the operator recorded. As previously discussed, the eyepiece scanner 17 may collect metadata upon actuation of the actuator 11. If the eyepiece scanner 17 is the only scanner included in the sensing device 10, then the eyepiece scanner 17 operates upon actuation of the actuator 11 without alerting the operator that his or her retina or iris scan is being captured.

The present embodiment, as part of an adequate watermarking system, curtails or eliminates several anticipated problems including: 1) the transfer of digital information to analog mode, such as transfer of pictures from photo-sites to developed prints, does not obliterate metadata used in the watermarks; 2) tracking data remains inextricably bound to the primary data and remains undetectable for normal usage, but is easily retrievable by watermark systems; 3) tracking information that is both in digital and analog forms; in analog mode, special readers with analog to digital converters that allow the reading of watermarks are provided; and 4) alterations of whatever shape or form has little or no effect on the watermarks, such that metadata are still retrievable from corrupted data. For example, if a digital picture were transformed into an analog print and then scanned back in and modified, the modification should not have any effect on the watermark in a system in accordance with the present embodiment. The actual embedding of the metadata into the sensed data may be performed in any method known to one of ordinary skill in the art.

Once the watermarked data is created for tracing, tracking and authenticating applications, the metadata encoded in the watermarked data is obtained by an inverse function in a watermarking system. This metadata can be used in any shape or form by the individual or entity collecting it.

Although the features and elements of the present invention are described in the preferred embodiments in particular combinations, each feature or element can be used alone without the other features and elements of the preferred embodiments or in various combinations with or without other features and elements of the present invention. For example, in a preferred embodiment of the present invention, the metadata such as fingerprint data is collected via an optical scanner such as an optical scanner used to read fingerprints on the sensing device. Additionally, the scanners are depicted as being disposed upon the sensing device in a preferred embodiment, however, the scanners to collect the metadata can be operatively connected to the sensing device in any manner known to one of ordinary skill in the art.

What is claimed is:

1. In a sensing device which senses a subject to obtain sensed data, a method of watermarking the sensed data, the method comprising:
(a) temporarily storing the sensed data;
(b) collecting metadata associated with a user of the sensing device;
(c) temporarily storing the metadata; and
(d) generating watermarked data by watermarking the sensed data with the metadata.

2. The method of claim 1 wherein the sensing device includes an actuator for actuating the sensing device and step (b) further comprises collecting the metadata when the user comes into physical contact with the actuator.

3. The method of claim 1 wherein the metadata includes biometric data associated with at least one physical characteristic of the user.

4. The method of claim 3 wherein the biometric data includes fingerprint data.

5. The method of claim 3 wherein the biometric data includes iris data.

6. The method of claim 3 wherein the biometric data includes retina data.

7. The method of claim 1 wherein the metadata includes environmental data about the sensing device.

8. The method of claim 7 wherein the environmental data includes data about the temperature or humidity associated with the sensing device's environment.

9. The method of claim 1 wherein the metadata includes data identifying the sensing device.

10. A sensing device configured to sense a subject to obtain sensed data and to watermark the sensed data, the sensing device comprising:
a sensor for sensing the subject to obtain the sensed data;
a first memory device for temporarily storing the sensed data;
a first scanner for collecting metadata associated with a user of the sensing device;
a second memory device for temporarily storing the metadata; and
a watermarking processing unit in communication with the first and second memory devices, the watermarking processing unit being configured to generate watermarked data by watermarking the sensed data with the metadata.

11. The sensing device of claim 10 further comprising:
an actuator for actuating the sensing device and collecting the metadata when the user comes into physical contact with the actuator.

12. The sensing device of claim 11 wherein the actuator is a button disposed upon the first scanner.

13. The sensing device of claim 10 further comprising:
an eyepiece disposed upon the sensing device for the use to view the subject; and
a second scanner disposed within the eyepiece for collecting biometric metadata associated with the user.

14. The sensing device of claim 13 wherein the second scanner collects iris or retina data associated with the eyes of the user.

15. The sensing device of claim 10 wherein the metadata includes biometric data associated with at least one physical characteristic of the user.

16. The sensing device of claim 15 wherein the biometric data includes fingerprint data.

17. The sensing device of claim 15 wherein the biometric data includes iris data.

18. The sensing device of claim 15 wherein the biometric data includes retina data.

19. The sensing device of claim 10 wherein the metadata includes environmental data about the sensing device.

20. The sensing device of claim 19 wherein the environmental data includes data about the temperature or humidity associated with the sensing device's environment.

21. The sensing device of claim 10 wherein the metadata includes data identifying the sensing device.

22. An integrated circuit (IC) used in conjunction with a sensing device which includes a first scanner for collecting metadata associated with a user of the sensing device, the sensing device being configured to sense a subject to obtain sensed data and to watermark the sensed data, the IC comprising:
a first memory device for temporarily storing the sensed data;
a second memory device for temporarily storing the metadata; and
a watermarking processing unit in communication with the first and second memory devices, the watermarking processing unit being configured to generate watermarked data by watermarking the sensed data with the metadata.

23. The IC of claim 22 wherein the metadata includes biometric data associated with at least one physical characteristic of a user of the sensing device.

24. The IC of claim 23 wherein the biometric data includes fingerprint data.

25. The IC of claim 23 wherein the biometric data includes iris data.

26. The IC of claim 23 wherein the biometric data includes retina data.

27. The IC of claim 23 wherein the metadata includes environmental data about the sensing device.

28. The IC of claim 27 wherein the environmental data includes data about the temperature or humidity associated with the sensing device's environment.

29. The IC of claim 22 wherein the metadata includes data identifying the sensing device.
